(19) United States
(12) Patent Application Publication
(10) Pub. No.: US 2023/0061107 A1
(43) Pub. Date: Mar. 2, 2023

(54) ANTI SHOCK APPARATUS

(71) Applicant: Donald Heck JR, Brisbane, CA (US)

(72) Inventor: Donald Heck JR, Brisbane, CA (US)

(21) Appl. No.: 17/894,193

(22) Filed: Aug. 24, 2022

Related U.S. Application Data
(60) Provisional application No. 63/236,730, filed on Aug. 25, 2021.

(51) Int. Cl. H02G 3/18; H02G 3/12

(52) U.S. Cl. CPC H02G 3/18; H02G 3/121

(57) ABSTRACT

An apparatus for minimizing or preventing an electric shock to a user, such as, e.g., a technician or an electrician, during servicing of an electrical junction box, such as, e.g., located within a home, office building, or facility. Typically, in construction of commercial, industrial and some residential spaces, building codes require the use of a metal conduit, for holding electrical wires, which may terminate at the junction box. Servicing of the junction box may include, but is not limited to, the installation, removal or trouble shooting of the box and/or its contents contained within. Electrical assemblies are frequently crowded environments in which it can be dangerous or difficult to handle components with the fingers. During usage, the apparatus may encompass an entire device on both left and right sides to prevent an electrical conductor, such as, e.g., another switch, outlet, mud ring, or junction box, from touching the device thereby minimizing the possibility of shorting an electrical connection during the servicing of the device, while the top and bottom portions may comprise openings for the device's mounting strap or yoke to protrude from.

### FIELD OF TECHNOLOGY

This disclosure relates generally to a hand tool for holding electrical outlets to prevent or minimize electrical shocks during servicing of junction boxes.

### BACKGROUND

A junction box—also known as an “outlet box”, “electrical box”, “jbox”, or “terminal box”—is a cover wherein wires are interconnected. Junction boxes are typically built into the plaster of a wall, in the ceiling, or within concrete. They are standard within most homes, buildings, and factories and serve a variety of purposes, such as, e.g., protect people from coming into contact with live wires, protect wires from dust and dampness, prevent small critters from chewing on the wires, organizes the electrical floorplan into units, and prevent fire within them from spreading when properly covered. In short, junction boxes serve as a protective casing for a section of wires, and can be found both indoors and outdoors. Waterproof junction boxes are commonly used outdoors.

One or more devices, such as, e.g., switches and outlets, are often times housed within a junction box. The devices are necessary to supply power to electrically powered fixtures, such as, e.g., a lamp. The box permits the insertion of electrical wires which are terminated at the devices. The devices may be mounted to the box, which provides protection to the devices, as well as the wires terminated therein. The junction box is then mounted to a wood or metal wall stud at a convenient location to provide access. Typically, junction boxes are in the shape of a rectangular cube, which has an opening positioned adjacent the stud. An outer covering of the wall can have an aperture cut within it, such that the inside of the box can be accessed. Safety and building codes require a metal cover, or mud ring, closing the electrical junction when it is installed. Further, the metal cover accommodates a variety of devices. There are a range of rings with different sizes of extended cutouts and protrusions that correlate with the thickness of the finished wall.

Most electrical junction boxes are made of a metal or plastic, e.g., a polymer. Metal junction boxes, such as, e.g., carbon steel, aluminum, and stainless steel, have the advantages of being stronger, more UV stable and flame resistant compared to plastic junction boxes, such as, e.g., PVC, ABS, and fiberglass. They are also able to maintain their strength at both high and low temperatures. The downside is that metal electrical junction boxes are higher cost, heavier, and conductive. Because they are conductive, metal junction boxes pose an inherent risk of electrical shock to a technician, such as, e.g., while troubleshooting the box or device. Compounded with the dangers of an electrical shock are the difficult working conditions under which servicing of a junction box is accomplished. For example, the lighting or visual conditions are usually poor in partially completed buildings. Furthermore, the boxes are often installed in corner areas of walls or down low, adjacent the floor surface, all contributing to the increased chance of a potentially fatal accident.

### SUMMARY

An apparatus for minimizing or preventing an electric shock to a user, such as, e.g., a technician or an electrician, during servicing of an electrical junction box, such as, e.g., located within a home, office building, or facility. Typically, in construction of commercial, industrial and some residential spaces, building codes require the use of a metal conduit, for holding electrical wires, which may terminate at the junction box. Servicing of the junction box may include, but is not limited to, the installation, removal or trouble shooting of the box and/or its contents contained within. Electrical assemblies are frequently crowded environments in which it can be dangerous or difficult to handle components with the fingers. Accordingly, it is desirable to have tools that are small or portable, easily operable and manipulated by one hand, and which can grasp electrical components firmly for servicing.

During usage, the apparatus may encompass an entire device on both left and right sides to prevent an electrical conductor, such as, e.g., another switch, outlet, mud ring, or junction box, from touching the device thereby minimizing the possibility of shorting an electrical connection during the servicing of the device, while the top and bottom portions may comprise openings for the device's mounting strap or yoke to protrude from. Since the chances of a user, such as, e.g., a technician or electrician, being shocked are diminished the user may work faster and more efficiently. One or more pairs of clamping jaws extending from an interior of the apparatus may be configured to grip a top neck portion and/or a bottom neck portion of the mounting strap or yoke such that the device may be easily and safely removed from the junction box or mud ring by removal of the apparatus. The clamping jaws may be movable or adjustable from a wide, non-gripping position to a narrow, gripping position by an adjustment means. The positions may be determined by the user. For example, when the user inserts the apparatus thereby surrounding the device, the apparatus may be set in the non-gripping position. The user may then set the apparatus in the gripping position to take hold of the device prior to removal from the junction box or mud ring. The apparatus may be interconnected with the device being handled, and is able to capture and retain it until the user chooses to disconnect the tool from the work piece.

### BRIEF DESCRIPTION OF THE DRAWINGS

Figures are illustrated by way of example and are not limited to the accompanying drawings, in which, like references indicate similar elements.

FIG. 1 illustrates a perspective view of a single gang junction box.

FIG. 2 illustrates front views of double gang junction boxes.

FIG. 3 shows an electrical outlet assembly.

FIG. 4 is a front view of outlet assemblies mounted onto junction boxes.

FIG. 5 is a perspective view of a pre-wired junction box with an outlet assembly mounted thereon.

FIG. 6 is a front view of an outlet assembly mounted to a mud ring.

FIG. 7 is an exploded view of an electrical assembly for installation within a wall.

FIG. 8 is a rear top perspective view of the disclosed apparatus for minimizing or preventing an electric shock.

FIG. 9 is a front view of the disclosed apparatus for minimizing or preventing an electric shock.

FIG. 10 is a right side view of the disclosed apparatus for minimizing or preventing an electric shock.

FIGS. 11A-D illustrate various handle means of the disclosed apparatus for minimizing or preventing an electric shock.

FIG. 12 illustrates the disclosed apparatus being positioned in front of an electrical device.

FIG. 13 is a top view of the disclosed apparatus being positioned in front of an electrical device.

FIGS. 14A-B illustrate the disclosed apparatus disposed within a junction box during usage.

FIG. 15 is a side view of the disclosed apparatus disposed within a junction box during usage.

FIGS. 16A-F illustrate various configurations of clamping jaw prongs of the disclosed apparatus.

FIGS. 17A-F illustrate various configurations of serrations for clamping jaw prongs of the disclosed apparatus.

FIGS. 18A-B illustrate configurations for adjustment mechanisms of the disclosed apparatus.

### DETAILED DESCRIPTION

Although the present has been described with reference to specific examples, it will be evident that various modifications and changes may be made without departing from their spirit and scope. The modifications and variations include any relevant combination of the disclosed features. Equivalent elements, materials, processes or steps may be substituted for those representatively illustrated and described herein. Certain structures and features may be utilized independently of the use of other structures and features. In addition, the components shown in the figures, their connections, couplings, relationships, and their functions, are meant to be exemplary only, and are not meant to limit the examples described herein.

An apparatus for minimizing or preventing an electric shock to a user, such as, e.g., a technician or an electrician, during servicing of an electrical junction box, such as, e.g., located within a home, office building, or facility. Typically, in construction of commercial, industrial and some residential spaces, building codes require the use of a metal conduit, for holding electrical wires, which may terminate at the junction box. Servicing of the junction box may include, but is not limited to, the installation, removal or trouble shooting of the box and/or its contents contained within. Electrical assemblies are frequently crowded environments in which it can be dangerous or difficult to handle components with the fingers. Accordingly, it is desirable to have tools that are small or portable, easily operable and manipulated by one hand, and which can grasp electrical components firmly for servicing.

Junction boxes may be mounted within walls of a building complex. A mud ring may be affixed. An electrical device, such as, e.g., an outlet or a switch, may be installed directly onto a junction box or mud ring. The junction box may be configured to be installed at any desired location, such as, e.g., in an aperture in a panel of a wall structure. A cover plate may be attached to the device on the exterior of the wall, effectively concealing electrical connections. The apparatus may be manufactured from a non-metallic or non-conductive material, such as, e.g. a rubber or plastic, and may be resistant to fire, heat, damage, cracking, and/or chipping. In some cases, the apparatus is adjustable to accommodate a variety of device shapes and sizes. In other cases, it comes in a variety of shapes and sizes to accommodate the variety of device shapes and sizes, and may be of a unitary construction, or it may comprise a plurality of parts and segments joined together through a fastening means, such as, e.g., an adhesive or ultrasonic welding technique.

During usage, the apparatus may encompass an entire device on both left and right sides to prevent an electrical conductor, such as, e.g., another switch, outlet, mud ring, or junction box, from touching the device thereby minimizing the possibility of shorting an electrical connection during the servicing of the device, while the top and bottom portions may comprise openings for the device's mounting strap or yoke to protrude from. Since the chances of a user, such as, e.g., a technician or electrician, being shocked are diminished the user may work faster and more efficiently. One or more pairs of clamping jaws extending from an interior of the apparatus may be configured to grip a top neck portion and/or a bottom neck portion of the mounting strap or yoke such that the device may be easily and safely removed from the junction box or mud ring by removal of the apparatus. The clamping jaws may be movable or adjustable from a wide, non-gripping position to a narrow, gripping position by an adjustment means. The positions may be determined by the user. For example, when the user inserts the apparatus thereby surrounding the device, the apparatus may be set in the non-gripping position. The user may then set the apparatus in the gripping position to take hold of the device prior to removal from the junction box or mud ring. The apparatus may be interconnected with the device being handled, and is able to capture and retain it until the user chooses to disconnect the tool from the work piece.

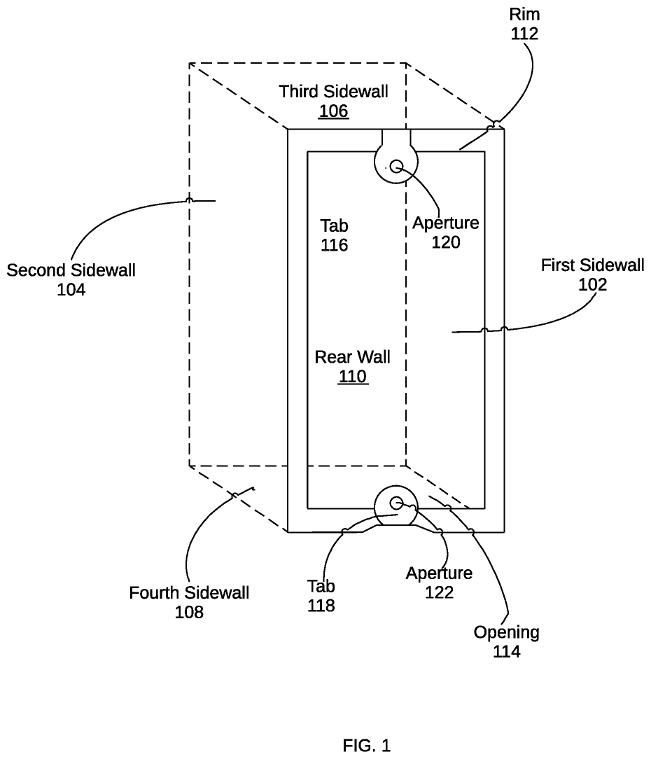

FIG. 1 illustrates a perspective view of a single gang junction box. The box can be of any known construction, such as, e.g., unitary, or formed from a number of plates secured together by means of interlocking tabs, projections, recesses and/or screws, and may include partially cut away portions, serving as knockouts, for the insertion of wires, cables, and/or clamps. An enclosure of the junction box may be divided into four individual side walls and a rear wall configured to house electrical wirings, terminations, and a device, such as, e.g., an electrical outlet or a switch.

A first sidewall 102 has an oppositely positioned and substantially parallel second sidewall 104. A third sidewall 106, or top wall, connects the first sidewall 102 and the second sidewall 104 and is substantially perpendicular to the first sidewall 102 and the second sidewall 104. An oppositely positioned fourth sidewall 108, or bottom wall, also connects the first sidewall 102 and the second sidewall 104 in the same manner as the third side wall 106. Rear wall 110 may be parametrically bound by orthogonally extending first sidewall 102, second sidewall 104, third sidewall 106, and fourth sidewall 108, terminating at rim 112 that defines an opening 114, and which together forms an interior of the enclosure of the junction box. Opening 114 may be configured for attachment of the electrical device. The enclosure may be mounted to a structural support, such as, e.g., a stud, by a fastening means. For example, various types of brackets may be attached to the enclosure, such as on rim 112 or one of the side walls. The brackets may comprise apertures for receiving nails, screws or other fastening means to secure the junction box against the structural support. Rim 112 may include opposing tab 116 and tab 118 having threaded aperture 120 and aperture 122, respectively, for engagement with assembly screws securing the device or other electrical components to the box member. The junction box may be made of a metal, such as, e.g., steel and/or aluminum; however, it is also possible that high strength plastic can be used, such as, e.g., acrylonitrile-butadiene-styrene (ABS), polyvinyl chloride (PVC), and/or glass-reinforced plastic (GRP). The depth, length and width of the junction box member are preferably in accordance with standard dimensions such that it may be installed in presently standardized wall constructions.

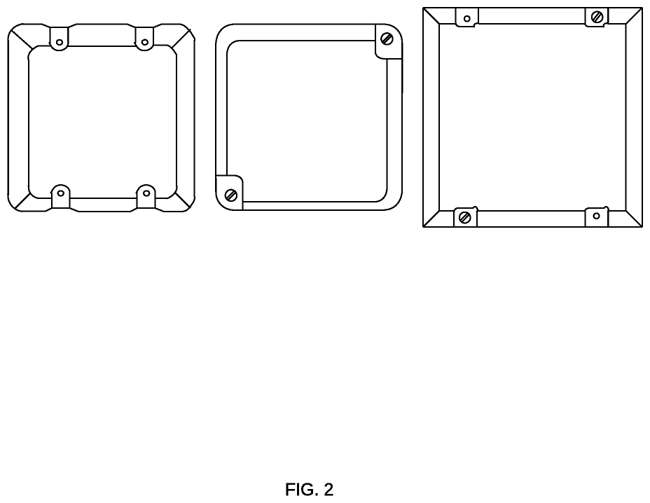

FIG. 2 illustrates front views of double gang junction boxes. The boxes may comprise any number of gangs, such as, e.g., three, four, five, six or more. In addition to the amount of devices that can be attached to each of the various gang junction boxes, other configurations can be employed. For example, mounting tabs can be either parallel and opposing, or diagonal. There may also be a number of different size boxes, such as, e.g., 4 inches by 4 inches, or 5.2 inches by 2.8 inches. Components of a junction box, such as, e.g., side walls and brackets, may be sized accordingly to accommodate. In addition, junction boxes may include a variety of shapes, such as, e.g., rectangular, circular, octagonal, or any other polygonal shape.

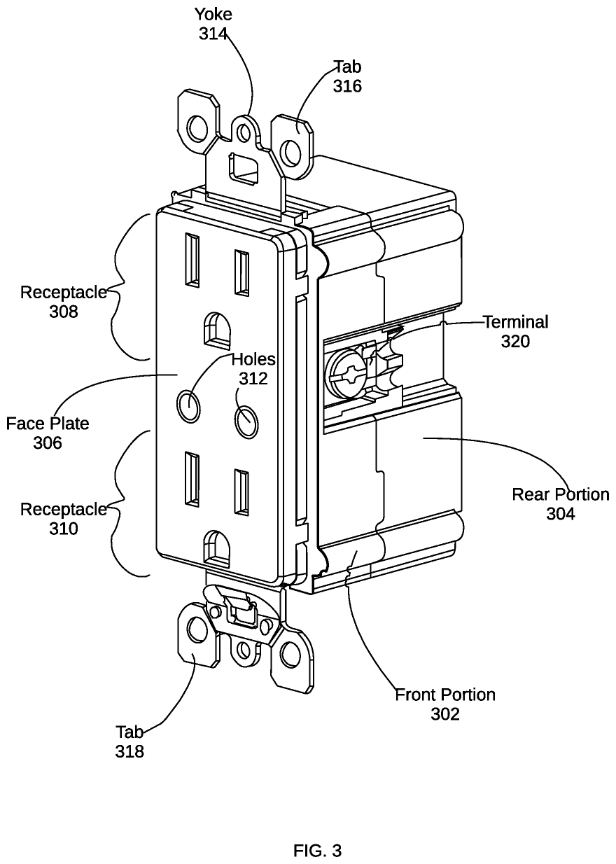

FIG. 3 shows an electrical outlet assembly. The outlet assembly may comprise a front portion 302 that includes a front casing, and a rear portion 304 that includes a back casing. Front portion 302 may be removably coupled to rear portion 304 through a fastening means, such as, e.g., clips or screws, and together form an enclosure, or housing, for protecting the components of the outlet. A face plate 306 may comprise receptacle 308 and receptacle 310. Mounting holes 312 may be formed at the center of face plate 306. Mounting strap or yoke 314 may be a single-piece metal, e.g., steel, wrap-around that provides mechanical strength to, and a point for grounding of, the receptacle. Twin-eared tab 316 and tab 318 may be disposed on a top portion and a bottom portion, respectively, of yoke 314. Tab 316 and tab 318 may include one or more apertures to receive a fastening means, such as, e.g., nails or screws, for aligning and mounting the outlet assembly to a junction box or a mud ring.

Receptacle 308 and receptacle 310 may be configured to accommodate a standard grounded plug for delivering power to a fixture, such as, e.g., a light bulb. Each receptacle may include a hot opening and a neutral opening positioned adjacent to one another, which are vertically extending parallel slots configured to receive the blades of the electrical plug of the fixture. The neutral blade opening may be located on the left side of receptacle 308 and receptacle 310. The hot blade opening may be located on the right side of receptacle 308 and receptacle 310 and is less than the length of the neutral blade slot. Both receptacles may further include a ground opening, located in the center below the hot and neutral blade openings, having a substantially half circular shape and configured to receive a grounded prong of an electrical plug of the fixture. Although two receptacles are shown here on the outlet assembly, other configurations may be used, such as, e.g., one, three, four, or more. In addition to conventional power receptacles, receptacle 308 and receptacle 310 may take other forms suitable for data and/or communications transmission, such as, e.g., coaxial cable, universal serial bus (USB), and/or Ethernet cable.

While not specifically illustrated, each of the hot blade opening, neutral blade opening, and ground opening include wirings and one or more contacts, positioned within the outlet assembly, that establish physical and electrical connection with the hot prong, neutral prong, and ground prong, respectively, of the plug. Terminal 320 may be provided for connecting the contacts of the outlet assembly to a hot lead or a neutral lead of an alternating current (AC) electrical system, and may be positioned on one or both sides of the assembly. Multiple terminals for the hot lead and multiple terminals for the neutral lead may be positioned on opposite sides of the outlet assembly, such that if desired, a separate hot lead and/or neutral lead can be connected to each of the terminals to provide an independent connection to each of the receptacles, thus allowing individualized control of fixtures and appliances that are plugged into each receptacle. If such individualized control is undesired or unnecessary, all of the terminals for the hot leads and all of the terminals for the neutral leads, respectively, are typically connected to each other such that a single hot lead and a single neutral lead can be connected to a single terminal and still be connected to each of the receptacles of the outlet assembly. This connection is generally severable to provide the individual control described above. In some cases, one or more ground terminals may also be provided with the outlet assembly.

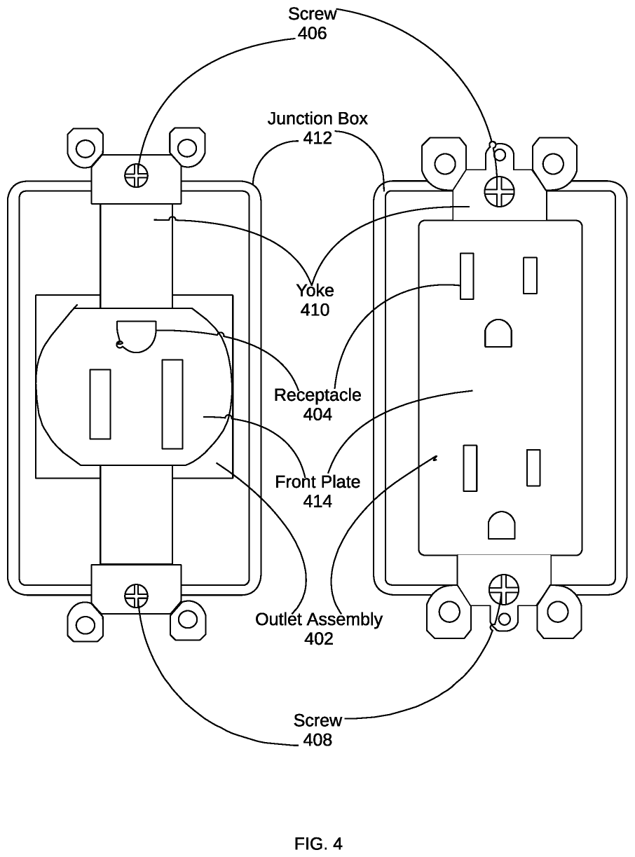

FIG. 4 is a front view of outlet assemblies mounted onto junction boxes. Each outlet assembly 402 may include one, two, or more receptacle 404. Screw 406 and screw 408 may engage with corresponding mounting holes of yoke 410 to secure outlet assembly 402 to a front opening of junction box 412. A rear enclosure, or housing, of outlet assembly 402 may rest within junction box 412, while front plate 414 of outlet assembly 402 may protrude from the opening of junction box 412. Junction box 412 may be mounted within an architectural separation, such as, e.g., an opening of a wall. A fastening means, such as, e.g., a bracket or a flange, may be used to secure junction box 412 to a stud within the architectural opening.

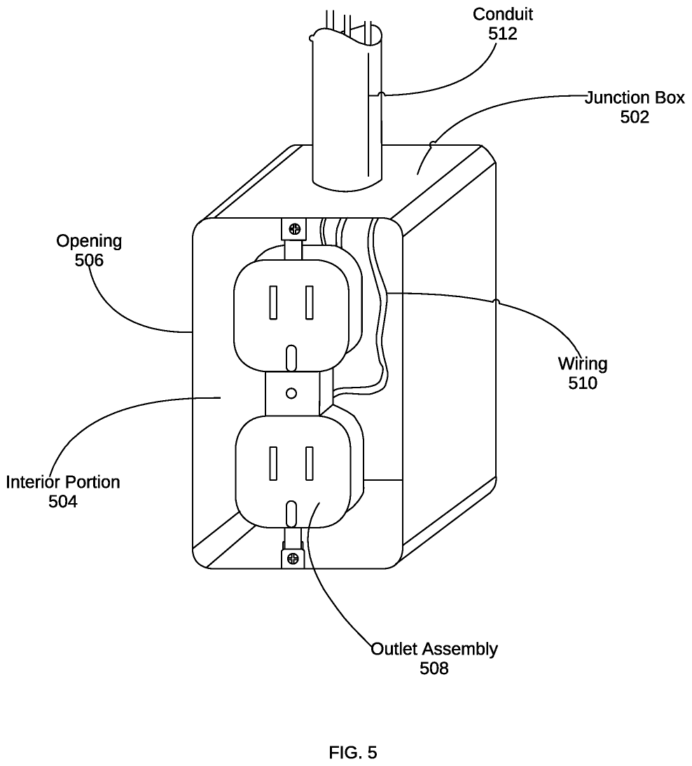

FIG. 5 is a perspective view of a pre-wired junction box with an outlet assembly mounted thereon. Junction box 502 may comprise an enclosure formed from four side walls and a rear wall, an interior portion 504, and an opening 506. Outlet assembly 508 is shown attached to junction box 502 and is wired with wiring 510. A conduit 512 may be affixed to junction box 502 and has wires passing through. Junction box 502 may also have an attachment means, such as, e.g., brackets or flanges, for attachment to a stud of an architectural separation, such as, e.g., an opening of a wall.

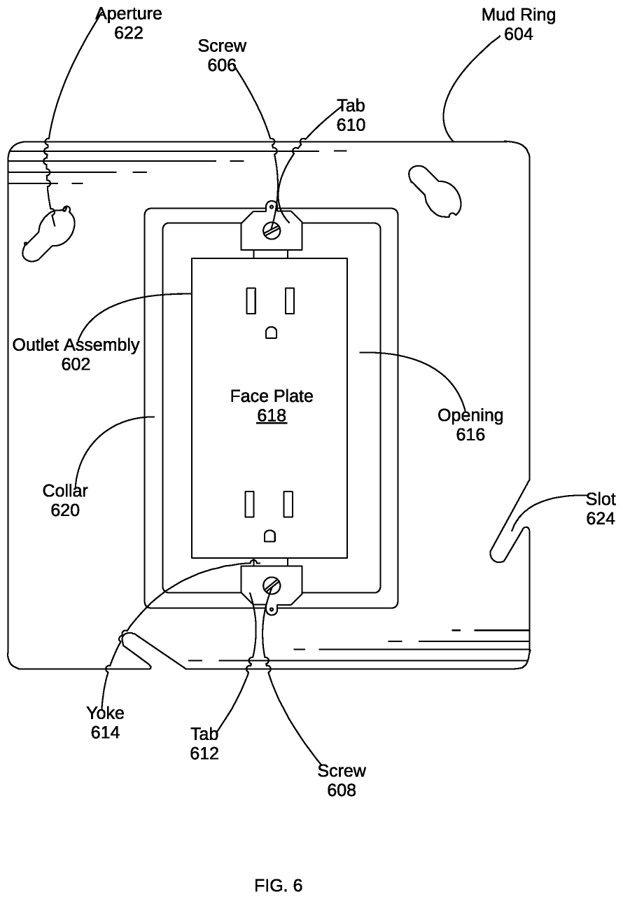

FIG. 6 is a front view of an outlet assembly mounted to a mud ring. Instead of being mounted directly to a junction box, outlet assembly 602 may be secured to mud ring 604 by screw 606 and screw 608 which are both inserted through apertures of tab 610 and tab 612, respectively, of yoke 614. Correspondingly, mud ring 604 may comprise apertures for receiving screw 606 and screw 608. Outlet assembly 602 may be inserted into opening 616 of mud ring 604 such that face plate 618 protrudes forward beyond collar 620. Collar 620 may be box shape for receiving a yoke of an outlet assembly or switch, and may extend perpendicularly forward to a set amount of distance, or may be adjustable, to enable outlet assembly 602 to be positioned at a selectable range from the junction box. Mud ring 604 may be rectangular shape, circular shape, or any other shape to accommodate an electrical junction box, and may be used when finished wall depth is unknown or changes, e.g., when junction boxes are mounted onto a stud before the drywall is installed. In some cases, mud ring 604 may be collar-less. A plurality of aperture 622 and slot 624 may be disposed near or at the perimeter of mud ring 604 for affixing to the junction box via a fastening means, such as, e.g., screws or bolts.

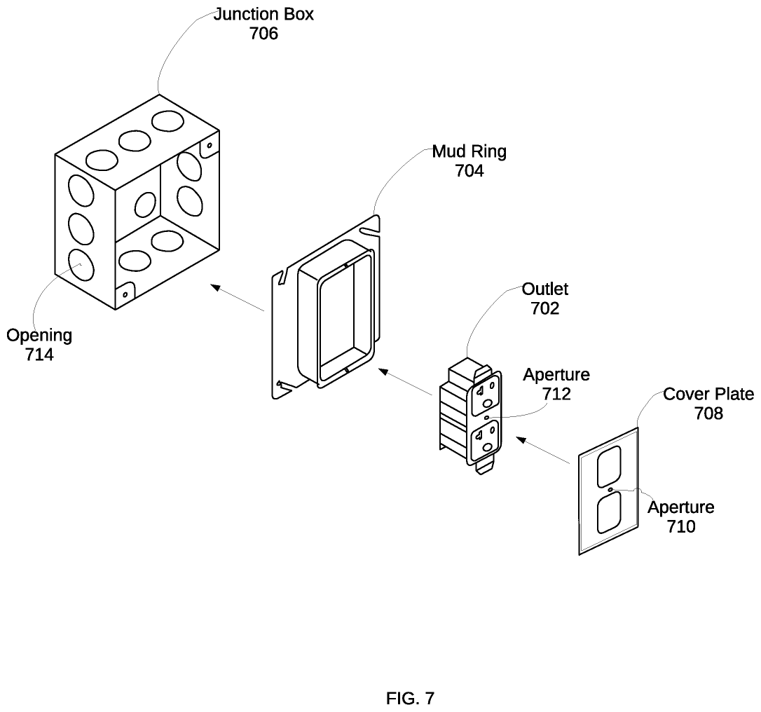

FIG. 7 is an exploded view of an electrical assembly for installation within a wall. Outlet 702 may be fitted over mud ring 704, rather than directly onto the side walls of junction box 706. In some cases, outlet assembly 702 is secured to junction box 706, rather than onto mud ring 704. Mud ring 704 may extend through an opening in the wall and be flush to an exterior surface of the wall. Cover plate 706 may comprise a substantially planar surface surrounded by a rearwardly tapered peripheral rim, and may be mounted onto outlet 702 through a fastening means, such as, e.g., screws, inserted into aperture 710 of cover plate 706 and threaded into corresponding aperture 712 of outlet 702. Cover plate 706 may be provided with openings, allowing one or more receptacles of outlet 702 to protrude through, while hiding electrical connections and the rest of outlet 702, mud ring 704, and/or junction box 706. Junction box 706 may comprise one or more opening 714 for insertion of electrical wires to be connected to outlet 702. In some cases, another device, such as, e.g., a switch, is used in substitute of outlet 702, and a corresponding switch cover plate is used in substitute of cover plate 708.

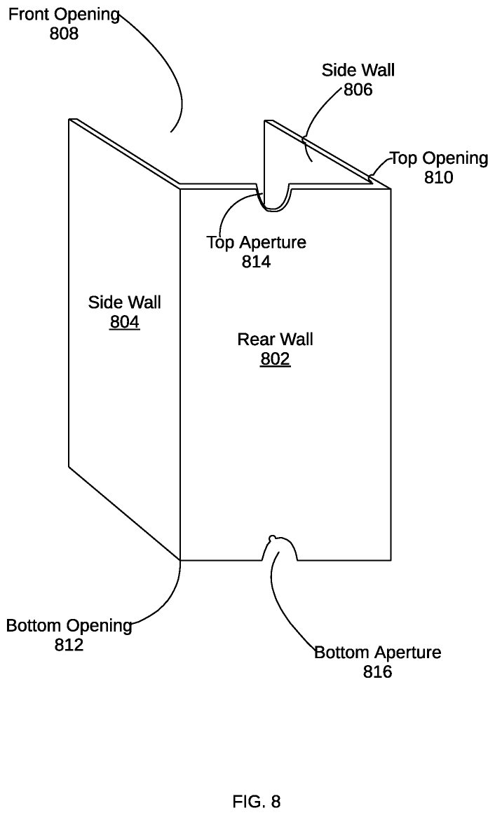

FIG. 8 is a rear top perspective view of the disclosed apparatus for minimizing or preventing an electric shock. The apparatus may be defined by planar rear wall 802, right side wall 804, and left side wall 806. Each of the walls may be substantially rectangular shape and perpendicular to its adjoining wall. For example, rear wall 802 may be perpendicular to side wall 804 and side wall 806. The apparatus may be substantially cube shape with three missing walls disposed at front opening 808, top opening 810, and bottom opening 812. Rear wall 702 may comprise a top aperture 814 and bottom aperture 816 for accommodating a fastening tool, such as, e.g., a screwdriver. The apparatus may be of a unitary construction or it may comprise a plurality of parts and segments joined together through a fastening means, such as, e.g., an adhesive or ultrasonic welding technique, and may be sized such that it fits into an opening of a junction box or a mud ring while fully encompassing an electrical device, e.g., an outlet assembly or switch, on both left and right sides, while leaving the top and bottom exposed to a mounting strap or yoke of the device. Although depicted here as cube shape, the apparatus can take any other form, such as, e.g., spherical, pyramidal, or other polygonal shapes, in order to accommodate a correspondingly shaped device. The apparatus may be manufactured from a non-metallic or non-conductive material, such as, e.g. a rubber or plastic, and may be resistant to fire, heat, damage, cracking, and/or chipping.

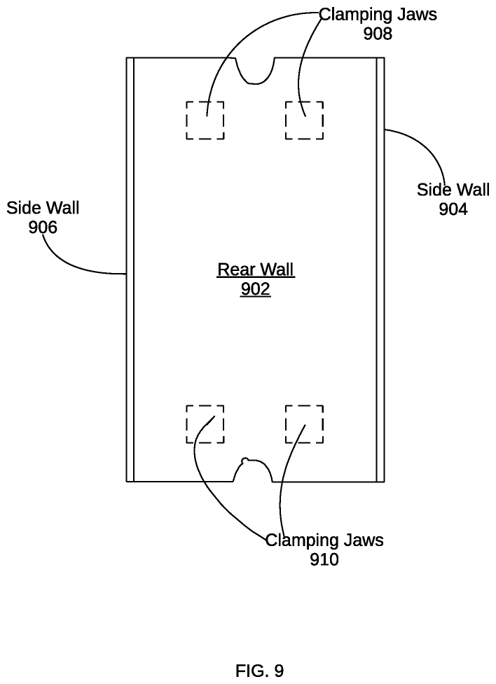

FIG. 9 is a front view of the disclosed apparatus for minimizing or preventing an electric shock. The apparatus may be substantially cube shape comprising rear wall 902, right side wall 904, and left side wall 906. Rear wall 902 may comprise a top pair of clamping jaws 908 and a bottom pair of clamping jaws 910 configured to grip a mounting strap or yoke of a device for easy and safe removal from a junction box or a mud ring of an electrical assembly. The dotted or broken lines signify that each prong of clamping jaws 908 and clamping jaws 910 may take any shape, form, or size to accommodate varying shapes, forms, and sizes of an electrical device, such as, e.g., an outlet or switch.

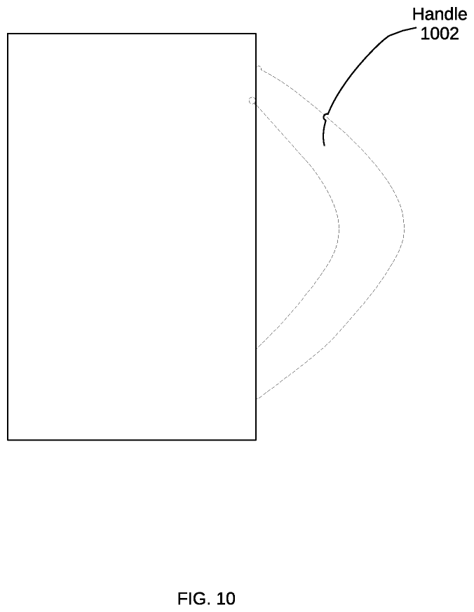

FIG. 10 is a right side view of the disclosed apparatus for minimizing or preventing an electric shock. The left side of the apparatus may be a mirror image of the right side, and is thus excluded from illustration. The apparatus may comprise a handle 1002 for safe handling of the apparatus by a user, such as, e.g., a technician or electrician, servicing an electrical assembly of a residential or commercial building complex. The dotted or broken lines signify that handle 1002 may take any shape, form, or size. For example, in the illustration handle 1002 comprising an arc shape curvature that is wider at a middle portion than top and bottom portions. An opening separates the apparatus from handle 1002 for insertion of a hand of the user for grasping.

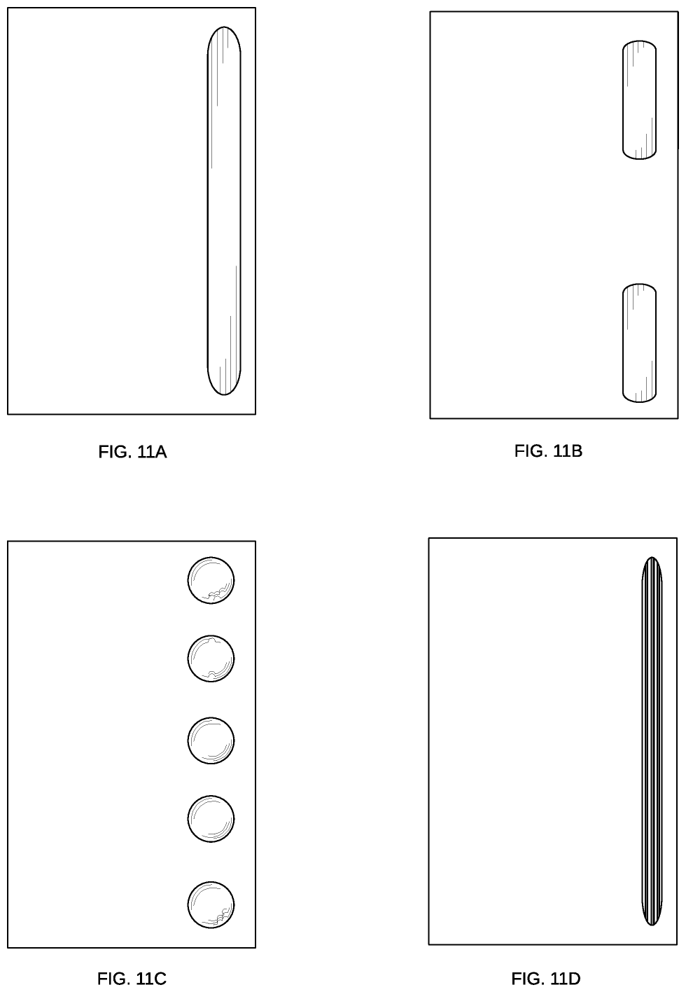

FIGS. 11A-D illustrate various handle means of the disclosed apparatus for minimizing or preventing an electric shock. In FIG. 11A, the handle means may be an indentation, or substantially grooved and adapted, to receive and conform to the user's fingers or thumbs. Although the handle means shown here is an oblong shape with rounded edges that stretches from top to bottom of a side wall of the apparatus, any other configurations may be implemented. For example, an elongated rectangle shape comprising sharp edges may be used. The handle means may be disposed at substantially the same or mirror locations on both the left and right sides. FIG. 11B shows a handle means that is a plurality of indentations adapted to receive and conform to the user's fingers or thumbs. Although the handle means shown here are a plurality of oblong shapes with rounded edges that are adjacent to one another from top to bottom of a side wall of the apparatus, any other configurations may be implemented. For example, a plurality of elongated rectangle shapes comprising sharp edges may be used. The handle means may be disposed at substantially the same or mirror locations on both the left and right sides. FIG. 11C illustrates a handle means that comprises a plurality of circular indentations adapted to received and conform to the user's finger tips. Any number of indentations may be used. For example, the apparatus may be configured for the user's left hand to grasp from the rear, and may comprise a different number of indentations on each side of the apparatus, such as, e.g., the left side may comprise a single indentation for receiving the user's thumb while the right side may comprise four indentations for receiving the user's fingers. Although the handle means shown here are a plurality of circular shapes that are adjacent to one another from top to bottom of a side wall of the apparatus, any other configurations may be implemented. For example, a plurality of rectangle shapes comprising sharp edges may be used. FIG. 11D shows a handle means that comprises a protrusion or projection for creating friction between the user's fingers and the apparatus. The protrusion or projection may comprise additional smaller, e.g., thinner, protrusions or projections for added friction and support. Although the handle means shown here is an oblong shape with rounded edges that stretches from top to bottom of a side wall of the apparatus, any other configurations may be implemented. For example, an elongated rectangle shape comprising sharp edges may be used. In addition, any number of protrusions can be used, such as, e.g., two or more. The handle means may be disposed at substantially the same or mirror locations on both the left and right sides. In each of FIGS. 11A-D, the handles means may be disposed towards a rear portion of the apparatus, and may benefit from less space usage and without a breakable part, as may be compared with other handle means.

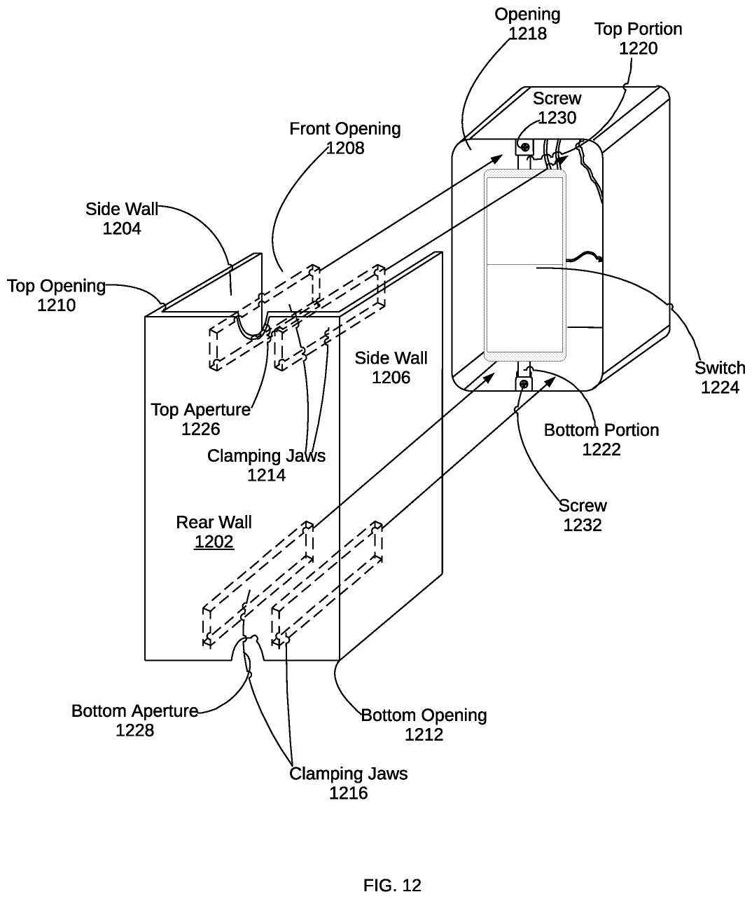

FIG. 12 illustrates the disclosed apparatus being positioned in front of an electrical device. The apparatus may comprise rear wall 1202, right side wall 1204, and left side wall 1206 forming substantially a cube shape with missing side walls disposed at front opening 1208, top opening 1210, and bottom opening 1212. Side wall 1204, and side wall 1206 of the apparatus and a top pair of clamping jaws 1214 and a bottom pair of clamping jaws 1216 protruding from within an inner surface of rear wall 702 may be inserted into a junction box or mud ring opening 1218. Side wall 1204 and side wall 1206 may be configured to surround the device to prevent an electrical conductor, such as, e.g., another switch, outlet, mud ring, or junction box, from touching the device thereby minimizing the possibility of shorting an electrical connection during the servicing of the device. Individual prongs of clamping jaws 1214 and clamping jaws 1216 may be positioned on both sides of a mounting strap or yoke's top portion 1220 and bottom portion 1222 of switch 1224—as indicated by the arrows—and configured to grip top portion 1220 and bottom portion 1222 horizontally. Top aperture 1226 and bottom aperture 1228 may accommodate a fastening tool, such as, e.g., a screwdriver, to fasten or loosen screw 1230 and screw 1232 of switch 1224, respectively. In some cases, the electrical device may be an electrical outlet. Although a single gang junction box is shown here, it is noted that the disclosed apparatus may be adapted to be used with other configurations of junction boxes, such as, e.g., two or more gang.

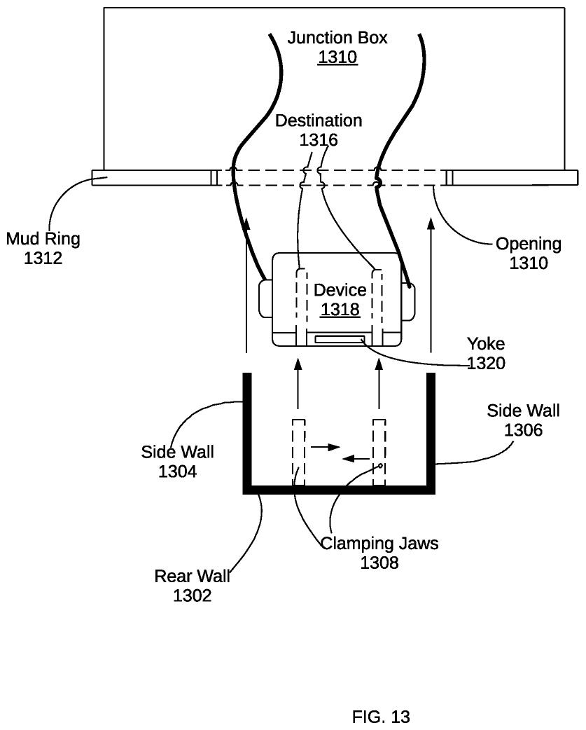

FIG. 13 is a top view of the disclosed apparatus being positioned in front of an electrical device. The apparatus may comprise rear wall 1302, right side wall 1304, and left side wall 1306, forming substantially a cube shape. Side wall 1304, and side wall 1306 of the apparatus, and top and bottom pairs of clamping jaws 1308 protruding from within an inner surface of rear wall 1302 may be inserted into a junction box 1310 or mud ring 1312 opening 1314, as indicated by the vertical arrows. Side wall 1304 and side wall 1306 may be configured to surround the device to prevent an electrical conductor, such as, e.g., another switch, outlet, mud ring, or junction box, from touching the device thereby minimizing the possibility of shorting an electrical connection during the servicing of the device. Clamping jaws 1308 may move towards destination 1316 of device 1318 for gripping yoke 1320 of device 1318. Individual prongs of clamping jaws 1308 may be positioned on both sides of a mounting strap or yoke's top portion and bottom portion of device 1318—as indicated by the horizontal arrows— and configured to grip the top portion and bottom portion horizontally.

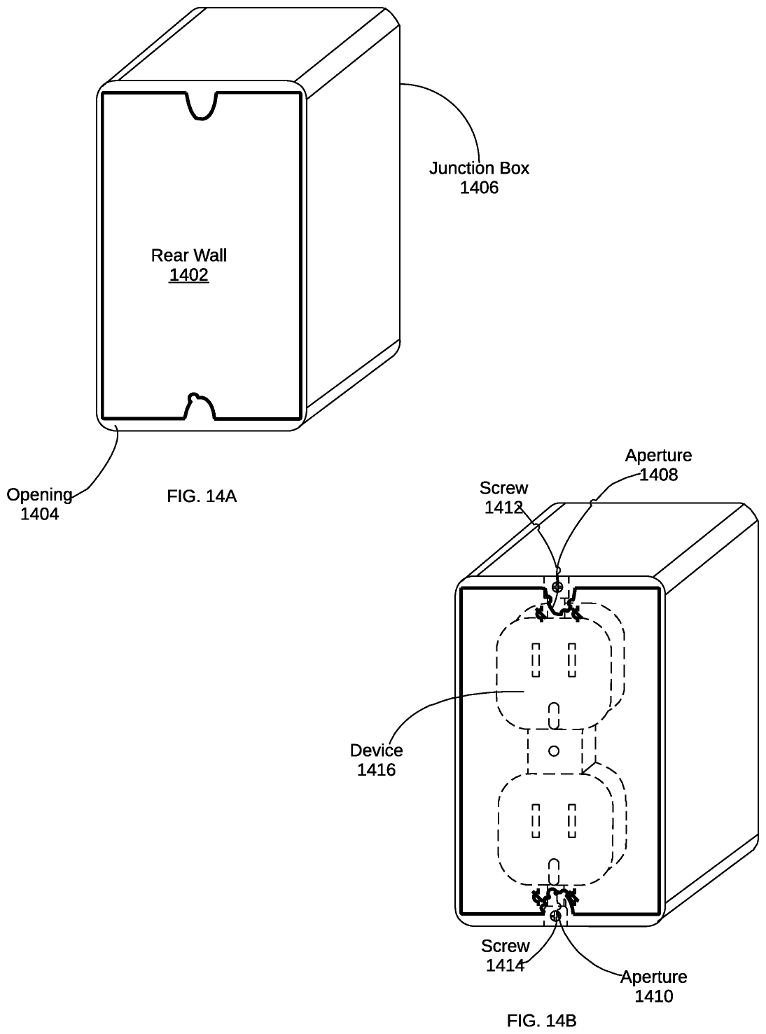

FIGS. 14A-B illustrate the disclosed apparatus disposed within a junction box during usage. In FIG. 14A, rear wall 1402 may be exposed and protrudes from opening 1404 of junction box 1406 after the side walls and clamping jaws of the apparatus has been inserted into opening 1404. In some cases, opening 1404 may be of a mud ring that is attached to junction box 1406. The perimeter of the apparatus may match opening 1404 in shape and may be smaller in dimensions, such that it may fit within opening 1404. The side walls of the apparatus may be configured to cover a device, such as, e.g., an outlet or switch, to prevent an electrical conductor, such as, e.g., another switch, outlet, mud ring, or junction box, from touching the device thereby minimizing the possibility of shorting an electrical connection during the servicing of the device. FIG. 14B shows electrical device 1416 in dotted or broken lines as it appears behind rear wall 1402. Each location of individual prongs of clamping jaws belonging to the apparatus are marked with an “x” indicating where the clamping jaws grip the mounting strap or yoke of device 1416, e.g., at a neck portion. Top aperture 1408 and bottom aperture 1410 may accommodate a fastening tool, such as, e.g., a screwdriver, for fastening or loosening screw 1412 and screw 1414, respectively.

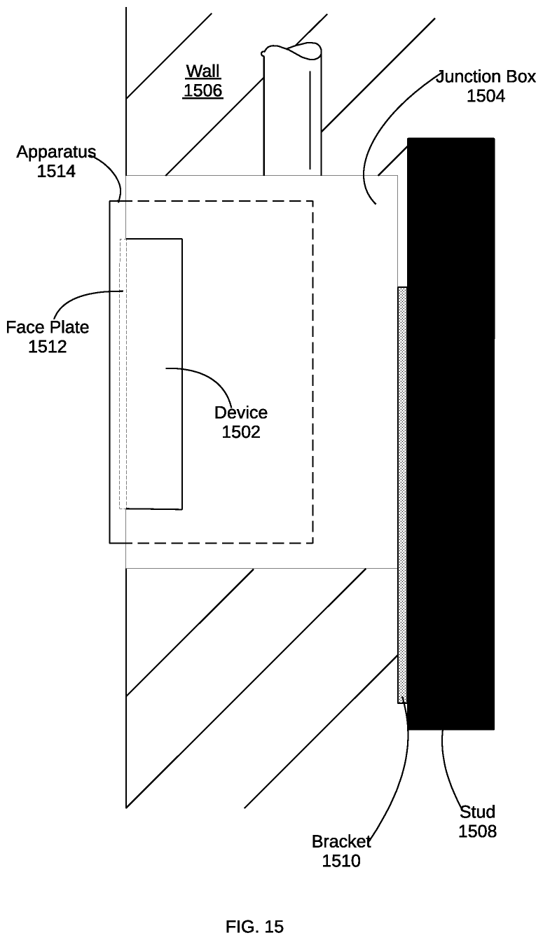

FIG. 15 is a side view of the disclosed apparatus disposed within a junction box during usage. Electrical device 1502, such as, e.g., an outlet or switch, may be secured to junction box 1504. Junction box 1504 may be installed within an opening or aperture of wall 1506, and may be mounted to a wood or steel stud 1508 through a fastening means, such as, e.g., bracket 1510. Bracket 1510 may be attached to various locations on the enclosure of junction box 1504, such as, e.g., a side wall or rim of an opening, and may include apertures for receiving nails, screws or other fastening means to secure junction box 1504 to stud 1508. Face plate 1512 of device 1502 may protrude from wall 1506. In some cases, device 1502 may be mounted onto a mud ring instead of directly onto junction box 1504. The mud ring may extend though the opening or aperture of wall 1506 and be flush to an exterior surface of wall 1506. Side walls of apparatus 1514 may encompass device 1502 in order to prevent an electrical conductor, such as, e.g., another switch, outlet, mud ring, or junction box, from touching device 1502 thereby minimizing the possibility of shorting an electrical connection during the servicing of device 1502.

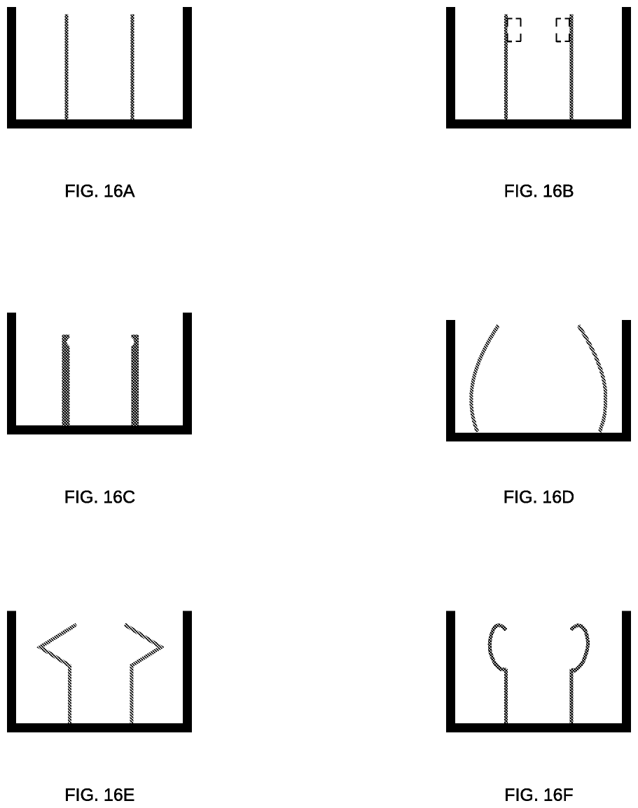

FIGS. 16A-F illustrate various configurations of clamping jaw prongs of the disclosed apparatus. The clamping jaws may be configured to grip or secure a top and/or a bottom portion of a mounting strap or yoke of an electrical device, such as, e.g., an outlet or a switch, that is mounted onto a junction box or mud ring. The clamping jaws may be movable or adjustable from a wide, non-gripping position to a narrow, gripping position by an adjustment means. The positions may be determined by a user, such as, e.g., a technician or electrician. For example, when the user inserts the apparatus thereby surrounding the device, the apparatus may be set in the non-gripping position. The user may then set the apparatus in the gripping position to take hold of the device prior to removal from the junction box or mud ring. Clamping jaws may generally be equal to, or shorter than, the side panels of the apparatus such that the side panels effectively shield the device to prevent an electrical conductor, such as, e.g., another switch, outlet, mud ring, or junction box, from touching the device thereby minimizing the possibility of shorting an electrical connection during the servicing of the device. Since the chances of a user, such as, e.g., a technician or electrician, being shocked are diminished the user may work faster and more efficiently. However, the design is not so limited and the clamping jaws may be configured to be longer than the side walls, if desired.

FIG. 16A illustrates straight clamping jaw prongs. The prongs may comprise smooth edges along its length, e.g., cylindrical shape, or sharp edges along its length, e.g., rectangular cube or box shape, or pyramidal shape with a planar gripping surface. The ends of the prongs facing outward from the rear wall of the apparatus may comprise smooth edges, e.g., rounded, or sharp edges, e.g., squared. FIG. 16B shows an adaptation of the straight clamping jaw prongs of FIG. 16A with a protrusion gripping surface at an end portion. The dotted or broken lines of the gripping surface signify that it can take any shape or form, such as, e.g., rectangular, spherical, triangular, or any other polygonal shape. FIG. 16C shows an adaptation of the straight clamping jaw prongs of FIG. 16A with an indentation or recess gripping surface at an end portion. The prongs may comprise smooth edges along its length, e.g., cylindrical shape, or sharp edges along its length, e.g., rectangular cube or box shape, or pyramidal shape. The ends of the prongs facing outward from the rear wall of the apparatus may comprise smooth edges, e.g., rounded, or sharp edges, e.g., squared. Near or at these ends, an indentation or recess may be configured to facilitate gripping of the mounting strap or yoke. The indentation or recess may comprise smooth edges, such as, e.g., a concave shape, or sharp edges, such as, e.g., a triangle or rectangle shape. There may be any amount of indentations or recesses, for example, two or more, and can span the entire length of the prongs, if desired. FIG. 16D illustrates curved clamping jaw prongs. The prongs may comprise smooth edges along its length, e.g., cylindrical shape, or sharp edges along its length, e.g., rectangular cube or box shape, or pyramidal shape. The ends of the prongs facing outward from the rear wall of the apparatus may comprise smooth edges, e.g., rounded, or sharp edges, e.g., squared. Any degree of curvature may be configured into the prongs. FIG. 16E illustrates straight clamping jaw prongs with a bend at an end portion. The sharp edges along its length, e.g., triangle or rectangle shape. The ends of the prongs facing outward from the rear wall of the apparatus may comprise smooth edges, e.g., rounded, or sharp edges, e.g., squared. Near or at these ends, a bend may be configured to facilitate gripping of the mounting strap or yoke. The bend may comprise sharp edges, such as, e.g., a triangle or rectangle shape. There may be any amount of bends, for example, two or more, and can span the entire length of the prongs, if desired. FIG. 16F illustrates another configuration of the straight clamping jaw prongs with a bend at an end portion. The prongs may comprise smooth edges along its length, e.g., cylindrical shape, or sharp edges along its length, e.g., rectangular cube or box shape, or pyramidal shape. The ends of the prongs facing outward from the rear wall of the apparatus may comprise smooth edges, e.g., rounded, or sharp edges, e.g., squared. Near or at these ends, a bend may be configured to facilitate gripping of the mounting strap or yoke. The bend may comprise smooth edges, such as, e.g., a concave shape. There may be any amount of bends, for example, two or more, and can span the entire length of the prongs, if desired.

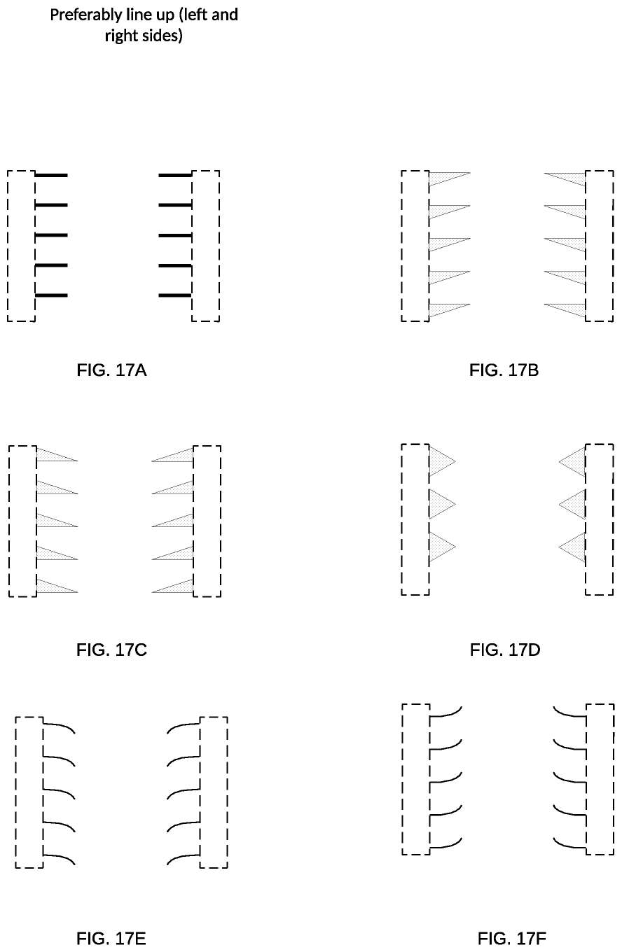

FIGS. 17A-F illustrate various configurations of serrations for clamping jaw prongs of the disclosed apparatus. In order to facilitate the gripping of a mounting strap or yoke of an electrical device, clamping jaw prongs of the apparatus may include rows of horizontal serrations on an inner surface. The serrations of a pair of clamping jaw prongs may be disposed on opposite or mirror image sides of one another such that they grip the mounting strap or yoke on both of its left and right sides. Each pair of serrations disposed on opposite or mirror image sides may line up and make contact at their terminal ends and create a gap between adjacent pairs for accommodating the mounting strap or yoke.

In FIG. 17A, clamping jaw prongs may include straight serrations. The serrations may comprise smooth edges along its length, e.g., cylindrical shape, or sharp edges along its length, e.g., rectangular cube or box shape, or pyramidal shape. The ends of the prongs facing outward from the rear wall of the apparatus may comprise smooth edges, e.g., rounded, or sharp edges, e.g., squared. Any amount of serrations may be included on each row, such as, e.g. one, two, or more. FIG. 17B illustrates triangular clamping jaw prong serrations. The triangle may be acute, and may include a flat surface facing the terminal ends of the apparatus sides and a slanted or angled surface facing the rear wall of the apparatus. FIG. 17C shows another configuration of the triangular clamping jaw prong serrations. The triangle may be acute, and may include a slanted or angled surface facing the terminal ends of the apparatus sides, and a flat surface facing the rear wall of the apparatus. FIG. 17D illustrates yet another configuration of the triangular clamp jaw prong serrations. The triangle may be equilateral, and may include slanted or angled surfaces facing both the terminal ends of the sides, and the rear wall, of the apparatus. In some cases the triangle may be obtuse. FIG. 17E illustrates curved clamping jaw prong serrations. The prongs may comprise smooth edges along its length, e.g., cylindrical shape, or sharp edges along its length, e.g., rectangular cube or box shape, or pyramidal shape. The terminal ends of the prongs may comprise smooth edges, e.g., rounded, or sharp edges, e.g., squared, and may point towards the rear wall of the apparatus. Any degree of curvature may be configured into the prongs. FIG. 17F illustrates another configuration of the curved clamping jaw prong serrations. The prongs may comprise smooth edges along its length, e.g., cylindrical shape, or sharp edges along its length, e.g., rectangular cube or box shape, or pyramidal shape. The terminal ends of the prongs may comprise smooth edges, e.g., rounded, or sharp edges, e.g., squared, and may point towards the terminal ends of the sides of the apparatus. Any degree of curvature may be configured into the prongs.

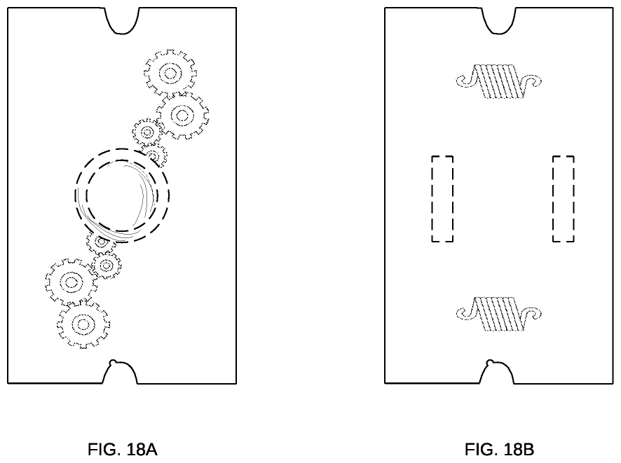

FIGS. 18A-B illustrate configurations for adjustment mechanisms of the disclosed apparatus. The apparatus may comprise clamping jaws that may be movable or adjustable from a wide, non-gripping position to a narrow, gripping position by an adjustment means. The positions may be determined by the user. For example, when the user inserts the apparatus thereby surrounding the device, the apparatus may be set in the non-gripping position. The user may then set the apparatus in the gripping position to take hold of the device prior to removal from the junction box or mud ring.

FIG. 18A illustrates a knob that operates a set of gears for adjustment of the disclosed apparatus. The gears may be located within a compartment of the apparatus internally or externally that may move the clamping jaws from the gripping position to the non-gripping position, and vice versa. The knob may be operated by the user before, during, or after servicing of an electrical assembly. FIG. 18B illustrates a spring loaded mechanism for adjustment of the disclosed apparatus. A spring assembly may be located within a compartment of the apparatus internally or externally that may move the clamping jaws from an open, non-gripping position to a closed, gripping position. The mechanism may be automatically set to the closed, gripping position by the spring load, which applies forces to both clamping jaws such that they come into contact. The user may apply opposite forces to open the clamping jaws such that they move away from one another in order to form a gap for accommodate the mounting strap or yoke. The application of the opposite forces may be through a leveraged mechanism, such as, e.g., a single press of a button, a gripping of a pair of levers, or a twist of a knob, in order to release the spring load. The dotted or broken lines show that this leveraged mechanism can take any shape or form.

Alternatively, the adjustment means may take the form of a self-locking plier mechanism having handles that support the clamping jaw prongs. The mechanism may include a link pivoted to one of the handles and slidable within a slot, a spring, and a threaded adjustment bolt. When the handles are drawn together, the prongs may be configured to close an amount determined by a setting of the adjustment bolt. Further, proper adjustment of the bolt allows the handles to be drawn together further after the clamping jaws engage the electrical device. Adjustment of bolt adjusts the degree of opening and closing of the clamping jaws so that they may be capable of gripping the mounting strap or yoke of the device of varying thicknesses.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added or removed. Accordingly, other examples are within the scope of the following claims.

What is claimed is:

1. An apparatus, comprising:
a first wall perpendicular to a second wall and a third wall;
a first opening perpendicular to a second opening and a third opening,
wherein the apparatus is configured to fit into an opening of a junction box or a mud ring,
wherein the apparatus fully encompasses an electrical device when inserted into the junction box or mud ring, and
wherein the apparatus is made from at least one of a rubber material and a plastic material.

2. The apparatus of claim 1, further comprising:
wherein the first wall comprises a top aperture and a bottom aperture.

3. The apparatus of claim 2, further comprising:
wherein the top aperture and the bottom aperture are configured to accommodate a fastening tool.

4. The apparatus of claim 3, further comprising:
wherein the fastening tool is a screwdriver.

5. The apparatus of claim 1, further comprising:
wherein the apparatus is cube-shape.

6. The apparatus of claim 1, further comprising:
wherein the apparatus is of a unitary construction.

7. The apparatus of claim 1, further comprising:
wherein the apparatus is configured to be held from the first wall by a user.

8. The apparatus of claim 1, further comprising:
wherein the first wall comprises one or more pairs of clamping jaws disposed on an inner surface.

9. The apparatus of claim 8, further comprising:
wherein the clamping jaws are configured to grip a mounting strap of the electrical device.

10. The apparatus of claim 8, further comprising:
wherein the clamping jaws comprise an adjustment means for modifying a space between the clamping jaws.

11. The apparatus of claim 1, further comprising:
wherein the first wall comprises a handle disposed on an outer surface.

12. The apparatus of claim 1, further comprising:
wherein at least one of the second wall and the third wall comprises a handle means.
